(19) United States
(12) Patent Application Publication
(10) Pub. No.: US 2026/0074184 A1
(43) Pub. Date: Mar. 12, 2026

(54) ELECTRODE ASSEMBLY AND SECONDARY BATTERY INCLUDING SAME

(71) Applicant: SAMSUNG SDI CO., LTD., Yongin-si (KR)

(72) Inventor: Hyunjin HWANG, Yongin-si (KR)

(21) Appl. No.: 19/071,556

(22) Filed: Mar. 5, 2025

(30) Foreign Application Priority Data
Sep. 11, 2024 (KR) 10-2024-0123669

(51) Int. Cl. H01M 4/13; H01M 10/0585; H01M 10/42; H01M 50/178; H01M 50/533; H01M 50/534; H01M 50/54; H01M 50/586; H01M 50/59

(52) U.S. Cl. CPC H01M 4/13; H01M 10/0585; H01M 10/4235; H01M 50/178; H01M 50/533; H01M 50/534; H01M 50/54; H01M 50/586; H01M 50/59

(57) ABSTRACT

The present disclosure relates to an electrode assembly including a first electrode portion including a plurality of electrodes, a separator, and an electrode tab on each of the plurality of electrodes. The electrode assembly may further include a second electrode portion on at least one surface of the first electrode portion and electrically connected to the electrode tab.

### CROSS-REFERENCE TO RELATED APPLICATION

The present application claims priority to and the benefit of Korean Application No. 10-2024-0123669, filed on Sep. 11, 2024, in the Korean Intellectual Property Office, the entire disclosure of which is incorporated by reference herein.

### BACKGROUND

### 1. Field

The present disclosure relates to an electrode assembly and a secondary battery including the same.

### 2. Description of the Related Art

Unlike primary batteries that are not designed to be (re) charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

Various research and development efforts are being conducted to achieve weight reduction, cost reduction, safety improvement, and energy density improvement of secondary batteries. Electrode substrates made of metal may be heavy. To address this, composite substrates with relatively thin metal layers formed on opposite sides of an insulating layer made of a relatively light material such as polyethylene terephthalate (PET) may be used. The composite substrate may be made by welding a separate metal substrate to a thin metal layer to allow the metal layers formed on opposite sides of the insulating layer to conduct current to each other. Quality deterioration and the like may occur due to the welding process.

The above information disclosed in this Background section is for enhancement of understanding of the background of the present disclosure, and therefore, it may contain information that does not constitute related (or prior) art.

### SUMMARY

One or more embodiments of the present disclosure is directed to an electrode assembly and a secondary battery including the same.

These and other aspects and features of the present disclosure will be described in or will be apparent from the following description of embodiments of the present disclosure.

According to one or more embodiments of the present disclosure, an electrode assembly may include a first electrode portion including a plurality of electrodes, a separator, and an electrode tab on each of the plurality of electrodes, and a second electrode portion on at least one surface of the first electrode portion and electrically connected to the electrode tab.

In some embodiments, each of the plurality of electrodes may include an insulating film layer including an insulating material, a metal layer formed on first and second surfaces of the insulating film layer, an active material layer on the metal layer, and the electrode tab protruding from one side of the insulating film layer, the first and second both surfaces of the electrode tab include the metal layer without including the active material.

In some embodiments, the electrode tab formed on each of the plurality of electrodes form a plurality of electrode tabs, wherein the plurality of electrode tabs are aligned in a thickness direction in which the plurality of electrodes may be stacked.

In some embodiments, the second electrode portion may include a metal plate made of metal, and a coupling tab protruding from one side of the metal plate, wherein the coupling tab is aligned with the plurality of electrode tabs, and coupled to the plurality of electrode tabs.

In some embodiments, a width of the coupling tab may be formed to be larger than a width of the electrode tabs wherein the coupling tab is configured to surround the electrode tabs.

In some embodiments, the coupling tab may include a tab seating portion extending from the metal plate, the tab seating portion having a size corresponding to the electrode tab, and facing the electrode tab, and a tab coupling portion extending to opposite sides of the tab seating portion and surrounding the plurality of electrode tabs.

In some embodiments, the second electrode portion may further include an active material layer formed on at least one surface of the metal plate.

In some embodiments, the electrode tab formed on each of the electrodes form a plurality of electrode tabs, wherein the plurality of electrode tabs may be arranged at one or more different positions, wherein at least portions of the plurality of elected tabs overlap along a width direction of the insulating film layer.

In some embodiments, the second electrode portion may include a first auxiliary electrode including a first coupling tab arranged on a first surface of the first electrode portion and contacting a first surface of the plurality of electrode tabs, and a second auxiliary electrode including a second coupling tab arranged on a second surface of the first electrode portion and contacting a second surface of the plurality of electrode tabs.

In some embodiments, the first auxiliary electrode may include a first metal plate made of metal, and a first coupling tab protruding from one side of the first metal plate and in contact with a first surface of the plurality of electrode tabs.

In some embodiments, the second auxiliary electrode may include a second metal plate, and a second coupling tab protruding from one side of the second metal plate and in contact with a second surface of the plurality of electrode tabs, wherein the second coupling tab is coupled to the first coupling tab.

In some embodiments, the first coupling tab and the second coupling tab may be ultrasonically welded and overlap each other with the plurality of electrode tabs interposed therebetween.

In some embodiments, a width of the first coupling tab and a width of the second coupling tab may be equal to or greater than a total width of the plurality of electrode tabs.

In some embodiments, the plurality of electrodes may include a plurality of first electrodes and a plurality of second electrodes, and the second electrode portion may include a first auxiliary electrode portion arranged on at least one surface of the plurality of first electrodes and a second auxiliary electrode portion arranged on at least one surface of the plurality of second electrodes.

In some embodiments, a first electrode tab on a first electrode of the plurality of first electrodes and a second electrode tab on a second electrode of the plurality of second electrodes may protrude in the same direction without overlapping each other in a thickness direction in which the plurality of electrodes may be stacked.

In some embodiments, a first electrode tab formed on the first electrode tab on a first electrode of the plurality of first electrodes and a second electrode tab on a second electrode of the plurality of second electrodes protrude in opposite directions.

According to one or more embodiments of the present disclosure, a secondary battery may include an electrode assembly, a pouch in which the electrode assembly may be accommodated, and a strip terminal having a first end electrically connected to the electrode assembly and a second end protruding from outside of the pouch, where the electrode assembly may include a first electrode portion including a plurality of electrodes, a separator, and an electrode tab on each of the plurality of electrodes, and a second electrode portion on at least one surface of the first electrode portion, electrically connected to the electrode tab of the plurality of electrodes, and coupled to one end of the strip terminal.

In some embodiments, each of the plurality of electrodes may include an insulating film layer having an insulating material, a metal layer on first and second surfaces of the insulating film layer, an active material layer on the metal layer, and the electrode tab protruding from one side of the insulating film layer, where the first and second surfaces of the electrode tab may include the metal layer without including the active material layer.

In some embodiments, the electrode tab formed on each of the plurality of electrodes form a plurality of electrode tabs, wherein the plurality of electrode tabs may be aligned in a thickness direction in which the plurality of electrodes may be stacked, and the second electrode portion may include a metal plate, and a coupling tab protruding from one side of the metal plate, where the coupling tab may be aligned with the plurality of electrode tabs, and surround the plurality of electrode tabs to be coupled thereto.

In some embodiments, the electrode tab formed on each of the plurality of electrodes form a plurality of electrode tabs, where the plurality of electrode tabs may be arranged at one or more positions, where at least portions of the plurality of electrode tabs overlap along a width direction of the insulating film layer, and the second electrode portion may include a first auxiliary electrode including a first coupling tab arranged on one surface of the first electrode portion and in contact with a first surface of the plurality of electrode tabs, and a second auxiliary electrode including a second coupling tab arranged on a second surface of the first electrode portion and coupled to the first coupling tab and further in contact with a second surface of the plurality of electrode tabs.

According to some embodiments of the present disclosure, by stacking a plurality of electrode tabs and then coupling separate coupling tabs so as to surround the electrode tabs, a path for current may be formed (e.g., without welding).

However, aspects and features of the present disclosure are not limited to those described above, and other aspects and features not mentioned will be clearly understood by a person skilled in the art from the detailed description, described below.

### BRIEF DESCRIPTION OF DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 illustrates an exploded perspective view of an example of an electrode assembly according to some embodiments of the present disclosure.

FIG. 2 illustrates a perspective view of an example of a first electrode and a second electrode in an electrode assembly according to some embodiments of the present disclosure.

FIG. 3 illustrates a partial cross-sectional view of an example of a first electrode and a second electrode in an electrode assembly according to some embodiments of the present disclosure.

FIG. 4 illustrates a top plan view of an example in which a first electrode and a second electrode are aligned in an electrode assembly according to some embodiments of the present disclosure.

FIG. 5 illustrates a perspective view of an example of an auxiliary electrode portion in an electrode assembly according to some embodiments of the present disclosure.

FIG. 6 illustrates a side view of an example of an auxiliary electrode portion in an electrode assembly according to some embodiments of the present disclosure.

FIG. 7 illustrates a partially enlarged view of an example of an auxiliary electrode portion in an electrode assembly according to some embodiments of the present disclosure.

FIG. 8 illustrates a top plan view of an example before a coupling tab is coupled in an electrode assembly according to some embodiments of the present disclosure.

FIG. 9 illustrates a cross-sectional view of an example in which a coupling tab is coupled to a plurality of electrode tabs taken along line A-A in FIG. 8.

FIG. 10 illustrates a plan view of an example in which a first electrode tab and a second electrode tab protrude in the same direction in an electrode assembly according to some embodiments of the present disclosure.

FIG. 11 illustrates a plan view of an example in which a first electrode tab and a second electrode tab protrude in opposite directions in an electrode assembly according to some embodiments of the present disclosure.

FIG. 12 illustrates an exploded perspective view of an example of a secondary battery according to some embodiments of the present disclosure.

FIG. 13 illustrates an exploded perspective view of an example of an electrode assembly according to some embodiments of the present disclosure.

FIG. 14 illustrates a top plan view of an example in which a first electrode and a second electrode are disposed or arranged in an electrode assembly according to some embodiments of the present disclosure.

FIG. 15 illustrates a perspective view of an example of an auxiliary electrode portion in an electrode assembly according to some embodiments of the present disclosure.

FIG. 16 illustrates an exploded plan view of an example of an electrode assembly according to some embodiments of the present disclosure.

FIG. 17 illustrates a cross-sectional view of an example in which a coupling tab is coupled to a plurality of electrode tabs taken along line B-B in FIG. 16.

FIG. 18 illustrates an exploded perspective view of an example of a secondary battery according to some embodiments of the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

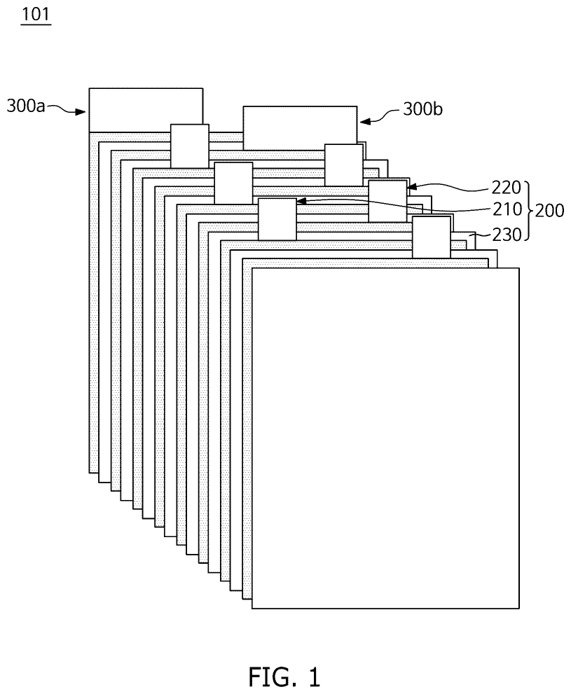

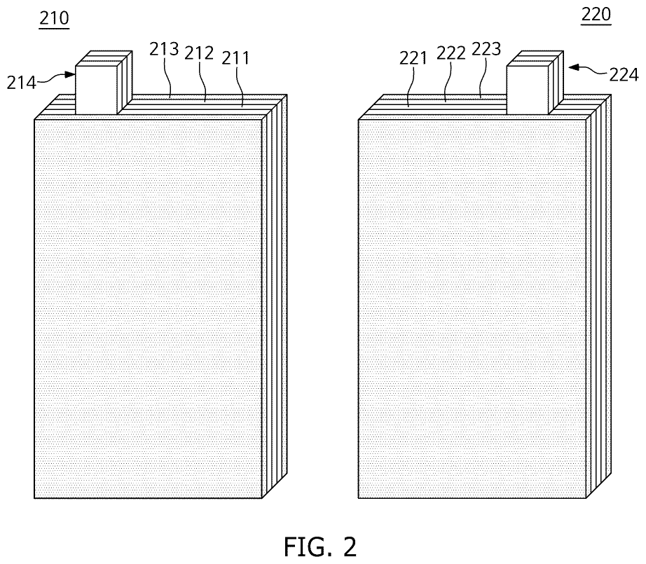

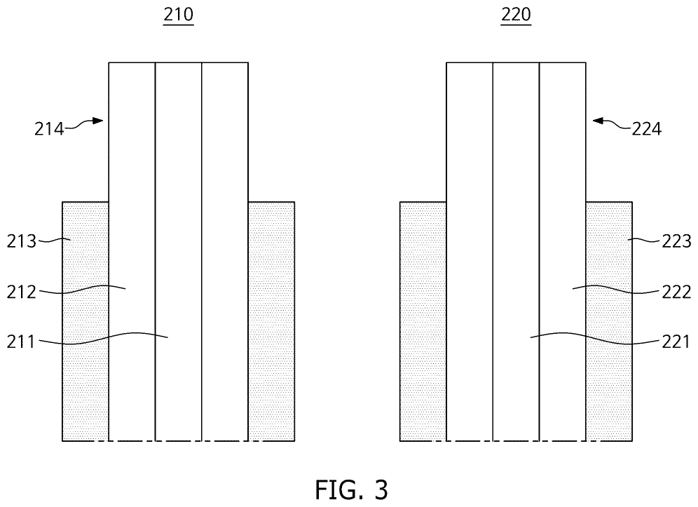

FIG. 1 illustrates an exploded perspective view of an example of an electrode assembly according to some embodiments of the present disclosure. FIG. 2 illustrates a perspective view of an example of a first electrode and a second electrode in an electrode assembly according to some embodiments of the present disclosure. FIG. 3 illustrates a partial cross-sectional view of an example of a first electrode and a second electrode in an electrode assembly according to some embodiments of the present disclosure.

Referring to FIG. 1 to FIG. 3, an electrode assembly 101 according to some embodiments of the present disclosure may include a first (also referred to as a main) electrode portion 200 including a plurality of electrodes 210 and 220 in which electrode tabs 214 and 224 are formed, a separator 230, and a second (also referred to as auxiliary) electrode portions 300a and 300b disposed or arranged on one or both surfaces of the main electrode portion 200 and electrically connected to the electrode tabs 214 and 224 of the electrodes 210 and 220.

In some embodiments, the electrodes 210 and 220 may include a plurality of first electrodes 210 and a plurality of second electrodes 220, and the auxiliary electrode portions 300a and 300b may include a first auxiliary electrode portion 300a disposed or arranged on one or both surfaces of the first electrodes 210 and a second auxiliary electrode portion 300b disposed or arranged on one or both surfaces of the second electrodes 220. The first electrode tabs 214 of the first electrodes 210 may be coupled to the first auxiliary electrode portion 300a, and the second electrode tabs 224 of the second electrodes 220 may be coupled to the second auxiliary electrode portion 300b. One or more (e.g., each of the electrodes 210 and 220 may include insulating film layers 211 and 221, metal layers 212 and 222, active material layers 213 and 223, and electrode tabs 214 and 224.

In some embodiments, the first electrode 210 may include a first insulating film layer 211 made of an insulating material, a first metal layer 212 formed on both (e.g., first and second) surfaces of the first insulating film layer 211, a first active material layer 213 formed on the first metal layer 212, and a first electrode tab 214 that protrudes from one side of the first insulating film layer 211 and has the first metal layer 212 formed on both surfaces thereof and no active material layer formed. In some embodiments, the first electrode tab 214 may include first and second surfaces that include the first metal layer 212 without including the active material layer.

In some embodiments, the second electrode 220 may include a second insulating film layer 221 made of an insulating material, a second metal layer 222 formed on both surfaces of the second insulating film layer 221, a second active material layer 223 formed on the second metal layer 222, and a second electrode tab 224 that protrudes from one side of the second insulating film layer 221 and has the second metal layer 222 formed on both surfaces of the tab, and the second active material layer 223 formed on both surfaces thereof and no active material layer formed. In some embodiments, the second electrode tab 220 may include first and second surfaces that include the second metal layer 222 without including the active material layer.

The insulating film layers 211 and 221 may be made of a polymer material. For example, the insulating film layers 211 and 221 may be made of a polyethylene terephthalate (PET) resin. In some embodiments, the materials of the insulating film layers 211 and 221 are not limited thereto, and the insulating film layers 211 and 221 may be made of a polyester resin such as polytrimethylene terephthalate (PTT), polybutylene terephthalate (PBT), or polyethylene naphthalate (PEN).

The metal layers 212 and 222 may be made of a metal material such as copper, a copper alloy, nickel, or a nickel alloy on the insulating film layers 211 and 221, or may be made of a metal material such as aluminum or an aluminum alloy.

The active material layers 213 and 223 may include a transition metal oxide or the like in a case where the metal layers 212 and 222 function as the positive electrodes, and may include graphite, carbon, or the like in a case where the metal layers 212 and 222 function as the negative electrodes.

In some embodiments, the first electrode 210 may function as a positive electrode. In this embodiment, the first metal layer 212 may be made of, for example, aluminum or an aluminum alloy, and the first active material layer 213 may include, for example, a transition metal oxide or the like.

The second electrode 220 may function as a negative electrode. In this embodiment, the second metal layer 222 may be made of, for example, copper, a copper alloy, nickel, or a nickel alloy, and the second active material layer 223 may include, for example, graphite, carbon, or the like. In some embodiments, the first electrode 210 may function as a negative electrode, and the second electrode 220 may function as a positive electrode.

The separator 230 prevents a short circuit between the first electrode 210 and the second electrode 220 while allowing movement of lithium ions therebetween. The separator 230 may be made of, for example, a polyethylene film, a polypropylene film, a polyethylene-polypropylene film, or the like.

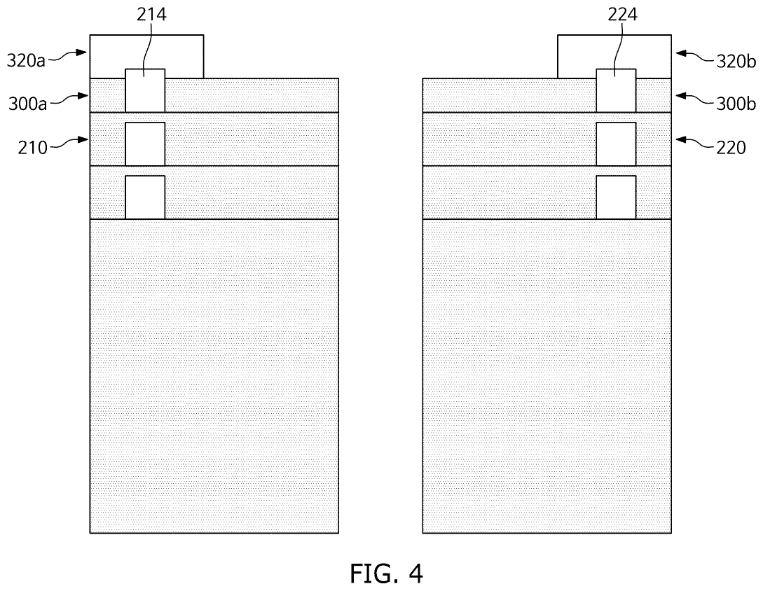

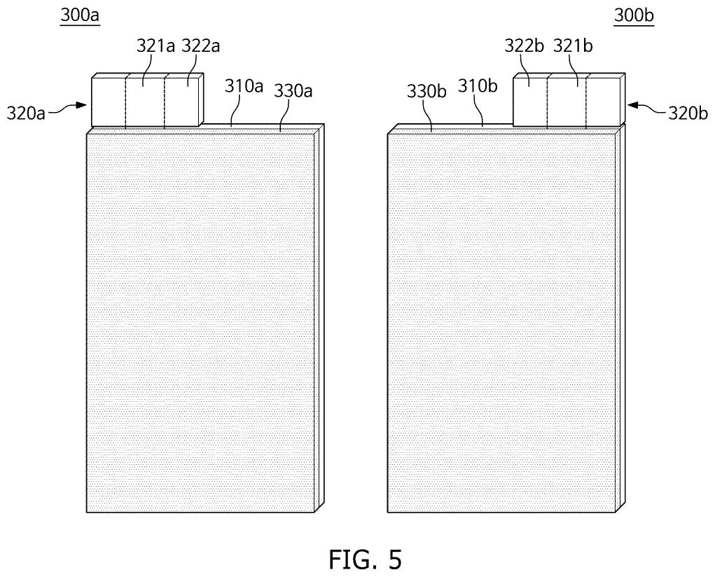

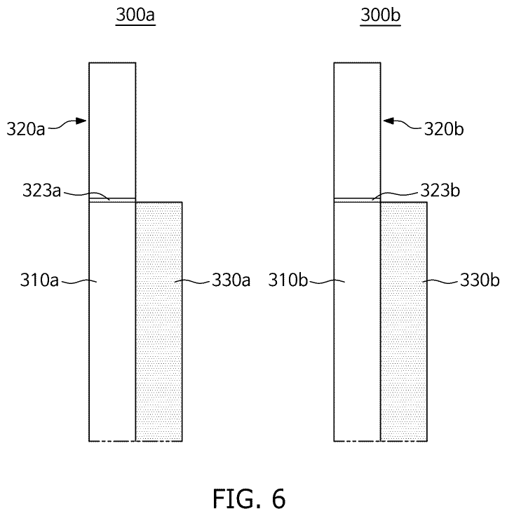

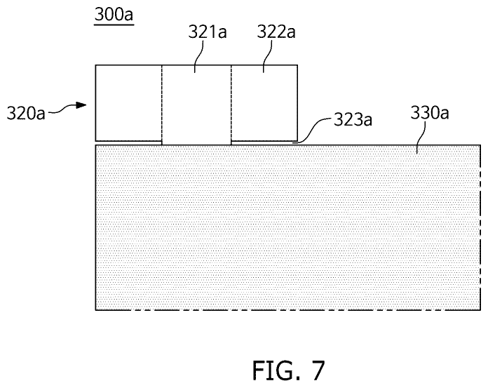

FIG. 4 illustrates a top plan view of an example in which a first electrode and a second electrode are aligned in an electrode assembly according to some embodiments of the present disclosure. FIG. 5 illustrates a perspective view of an example of an auxiliary electrode portion in an electrode assembly according to some embodiments of the present disclosure. FIG. 6 illustrates a side view of an example of an auxiliary electrode portion in an electrode assembly according to some embodiments of the present disclosure. FIG. 7 illustrates a partially enlarged view of an example of an auxiliary electrode portion in an electrode assembly according to some embodiments of the present disclosure.

Referring to FIG. 4 to FIG. 7, the auxiliary electrode portions 300a and 300b according to some embodiments of the present disclosure may include base plates 310a and 310b and coupling tabs 320a and 320b.

In some embodiments, the first auxiliary electrode portion 300a may include a first base plate 310a made of a metal material (first metal plate), and a first coupling tab 320a protruding from one side of the first base plate 310a, aligned with and coupled to the first electrode tabs 214. The second auxiliary electrode portion 300b may include a second base plate 310b made of a metal material (second metal plate), and a second coupling tab 320b protruding from one side of the second base plate 310b, aligned with and coupled to the second electrode tabs 224.

Because the first base plate 310a is coupled to the first electrode 210, it may be configured to have the same polarity as the first electrode 210. In some embodiments, in a case where the first electrode 210 functions as a positive electrode, the first base plate 310a may be formed of a metal substrate such as aluminum or an aluminum alloy. In some embodiments, a first active material layer 330a may be formed by coating a transition metal oxide or the like on one or both surfaces of the first base plate 310a.

The first coupling tab 320a may be a region in which the first active material layer 330a is not formed, and may be coupled to the first electrode tabs 214 to serve as a current flow path. In some embodiments, the first coupling tab 320a may extend from the first base plate 310a and be formed to have a size corresponding to the first electrode tabs 214, and may include a first tab seating portion 321a disposed or arranged to face the first electrode tabs 214, and a first tab coupling portion 322a extending from opposite sides of the first tab seating portion 321a and surrounding the first electrode tabs 214.

The first tab coupling portion 322a may be configured to be separate from the first base plate 310a. In some embodiments, the first tab seating portion 321a and the first tab coupling portion 322a may extend from the first base plate 310a, and a notch groove 323a may be formed between the first tab coupling portion 322a and the first base plate 310a by notching the first tab coupling portion 322a and the first base plate 310a. In this regard, the first tab coupling portion 322a may extend from opposite sides of the first tab seating portion 321a and be deformed to surround the side surfaces of the first electrode tabs 214 stacked on the first tab seating portion 321a.

Because the second base plate 310b is coupled to the second electrode 220, it may be configured to have the same polarity as the second electrode 220. In some embodiments, in a case where the second electrode 220 functions as a negative electrode, the second base plate 310b may be formed of a metal substrate such as copper, a copper alloy, nickel, or a nickel alloy. In some embodiments, a second active material layer 330b may be formed by coating graphite, carbon, or the like on one or both surfaces of the second base plate 310b.

The second coupling tab 320b is a region in which the second active material layer 330b is not formed and is coupled to the second electrode tabs 224, thereby providing a path for current flow. In some embodiments, the second coupling tab 320b may extend from the second base plate 310b and be formed to have a size corresponding to the second electrode tabs 224, and may include a second tab seating portion 321b that is disposed or arranged to face the second electrode tab 224, and a second tab coupling portion 322b that extends from opposite sides of the second tab seating portion 321b and surrounds the second electrode tabs 224.

Similar to the first tab coupling portion 322a, a notch 323b may be formed between the second tab coupling portion 322b and the second base plate 310b. Through this structure, the second tab coupling portion 322b extends from opposite sides of the second tab seating portion 321b and may be deformed to surround the side surfaces of the second electrode tabs 224 stacked on the second tab seating portion 321b.

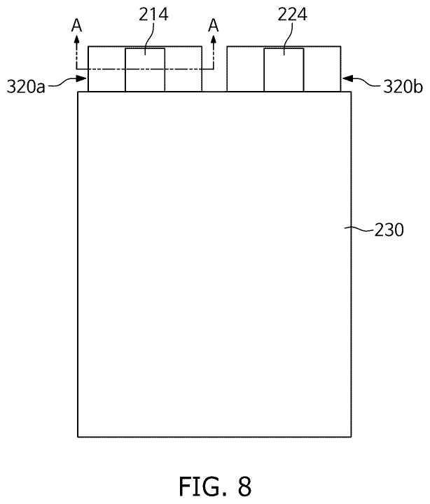

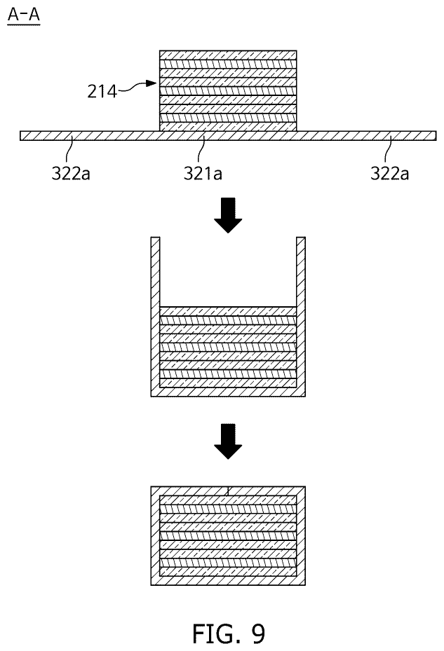

FIG. 8 illustrates a top plan view of an example before a coupling tab is coupled in an electrode assembly according to some embodiments of the present disclosure, and FIG. 9 illustrates a cross-sectional view of an example in which a coupling tab is coupled to a plurality of electrode tabs by being taken along line A-A in FIG. 8.

Referring to FIG. 8 and FIG. 9, the first electrode tabs 214 may be aligned in the thickness direction where the first electrodes are stacked. The first electrode tabs 214 are formed at the same position, so that in a case where the first electrodes are stacked, the first electrode tabs 214 may be aligned in the thickness direction at the same position. In some embodiments, the second electrode tabs 224 are formed at a different position so as not to overlap the first electrode tabs 214, and may be aligned in the thickness direction where the second electrodes are stacked.

The first electrode tabs 214 aligned in the thickness direction are disposed or arranged on the first tab seating portion 321a, and the first tab coupling portions 322a, which extend from opposite sides of the first tab seating portion 321a, may be bent to surround the side surfaces of the first electrode tabs 214 and coupled thereto. In some embodiments, in the stacked plurality of first electrode tabs 214, the metal layers that are disposed or arranged to be spaced apart from each other by a first insulating film layer may also be coupled to the first tab coupling portion 322a, thereby being electrically connected to each other and forming a path for current flow. Although not shown in the drawings, the second coupling tab 320b may similarly surround and couple to the second electrode tabs 224, thereby forming a path for current flow.

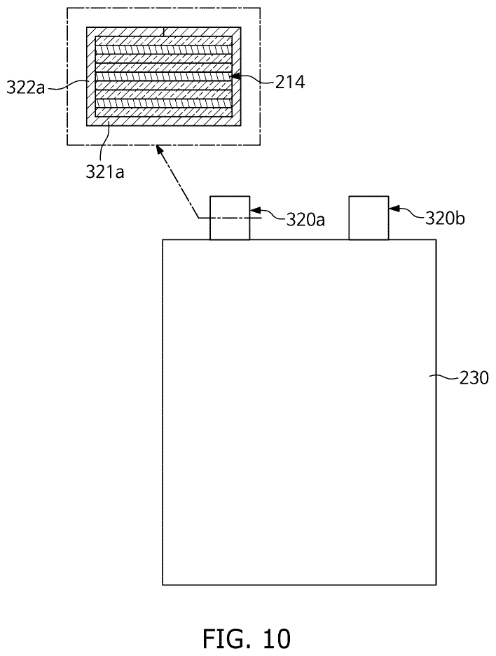

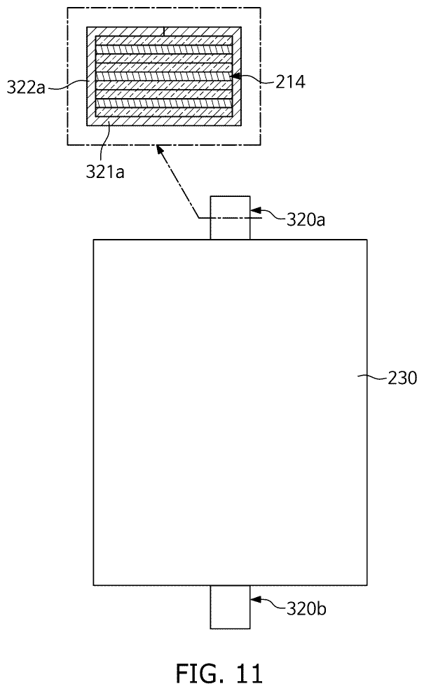

FIG. 10 illustrates a plan view of an example in which a first electrode tab and a second electrode tab protrude in the same direction in an electrode assembly according to some embodiments of the present disclosure, and FIG. 11 illustrates a plan view of an example in which a first electrode tab and a second electrode tab protrude in opposite directions in an electrode assembly according to some embodiments of the present disclosure.

Referring to FIG. 10, in the electrode assembly according to some embodiments of the present disclosure, the first electrode tab 214 formed on the first electrode and the second electrode tab formed on the second electrode may protrude in the same direction and may be disposed or arranged so that they do not overlap each other in the thickness direction where a plurality of electrodes are stacked. In some embodiments, the electrode tabs may be formed to have a unidirectional shape protruding in the same direction. In some embodiment, the stacked first electrode tabs 214 may be coupled while being surround by the first coupling tab 320a, and the stacked second electrode tabs may be coupled while being surrounded by the second coupling tab 320b.

In other embodiments, referring to FIG. 11, the first electrode tab 214 formed on the first electrode and the second electrode tab formed on the second electrode may protrude in opposite directions. That is, the electrode tabs may be formed to have a bidirectional shape protruding in opposite directions. In some embodiments, the stacked first electrode tabs 214 may be coupled while being surround by the first coupling tab 320a, and the stacked second electrode tabs may be coupled while being surrounded by the second coupling tab 320b.

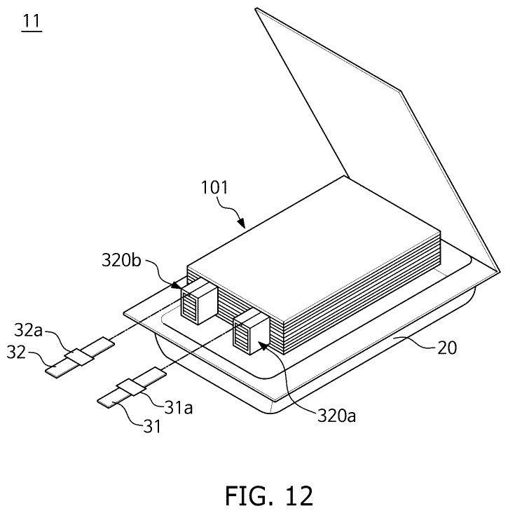

FIG. 12 illustrates an exploded perspective view of an example of a secondary battery according to some embodiments of the present disclosure.

Referring to FIG. 12, a secondary battery 11 according to some embodiments of the present disclosure may include an electrode assembly 101, a pouch 20 in which the electrode assembly 101 is accommodated, and strip terminals 31 and 32 having one end electrically connected to the electrode assembly 101 and the other end protruding outside the pouch 20. In some embodiments, the electrode assembly 101 has the same configuration as the electrode assembly 101 described above with reference to FIG. 1 to FIG. 10, so detailed descriptions thereof will be omitted.

The pouch 20 may be sealed by the edge portions contacting each other while the electrode assembly 101 and the electrolyte are accommodated therein. In some embodiments, the pouch 20 is made of a heat fusion material, and may be sealed by heat fusion.

The pouch 20 may include a plurality of layer structures. The pouch 20 may include a metal thin film and insulating layers formed on opposite sides of the metal thin film. The metal thin film may include a metal material such as steel, stainless steel, or aluminum. The insulating layer may include an insulating material such as nylon, polyethylene terephthalate (PET), or modified polypropylene (CPP). The insulating layer disposed or arranged on the outer surface of the metal thin film and the insulating layer disposed or arranged on the inner surface of the metal thin film may be made of different insulating materials. However, the material and shape of the pouch 20 are not limited thereto, and it may be made of any material and shape as long as it may accommodate and seal the electrode assembly 101 and the electrolyte therein.

The strip terminals 31 and 32 may include a first strip terminal 31 that is coupled to the first coupling tab 320a of the electrode assembly 101 to form a current path, and a second strip terminal 32 that is coupled to the second coupling tab 320b to form a current path. The first strip terminal 31 and the second strip terminal 32 are accommodated in the pouch 20 while one ends thereof are coupled to the first coupling tab 320a and the second coupling tab 320b, respectively, by welding or the like, and the other ends of the first coupling tab 320a and the second coupling tab 320b are disposed or arranged to protrude outside the pouch 20 to be electrically connected to external terminals.

In some embodiments more, a first insulating film 31a and a second insulating film 32a may be respectively disposed or arranged at portions of the first coupling tab 320a and the second coupling tab 320b that come into contact with the pouch 20. The sealed portion of the pouch 20 is made of a heat-fusion material, and may be bonded to each other by heat fusion to be sealed. Because the heat-fusion material generally has poor adhesion to metals, the first insulating film 31a and the second insulating film 32a are attached to the metal first strip terminal 31 and second strip terminal 32, respectively, to be more easily fused with the pouch 20.

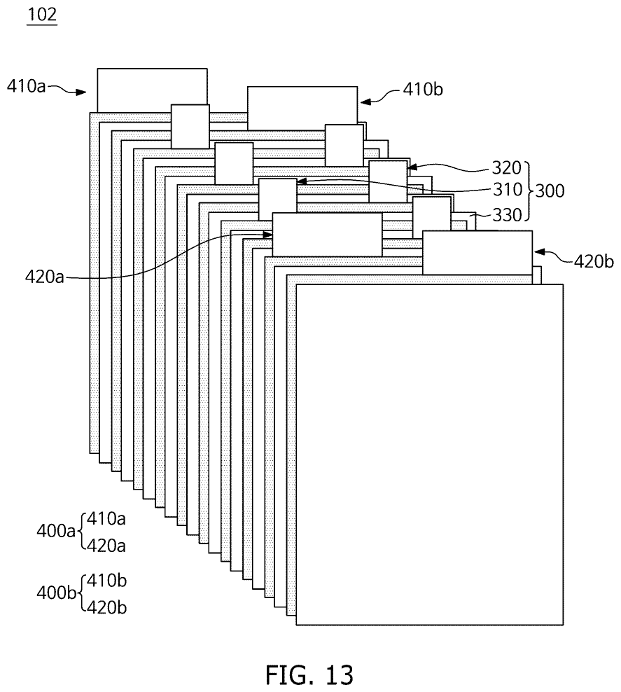

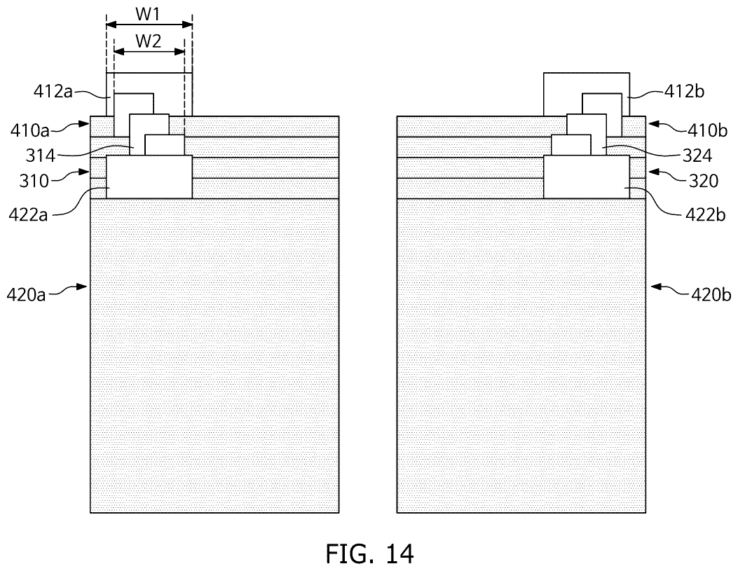

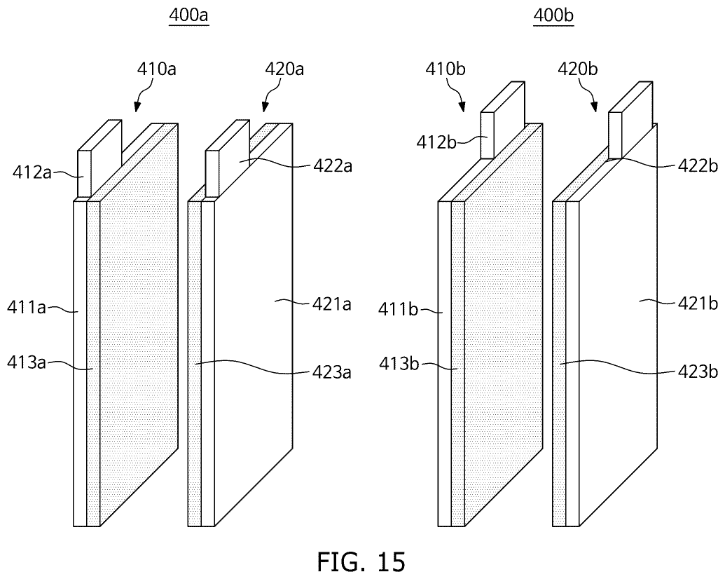

FIG. 13 illustrates an exploded perspective view of an example of an electrode assembly according to some embodiments of the present disclosure, FIG. 14 illustrates a top plan view of an example in which a first electrode and a second electrode are disposed or arranged in an electrode assembly according to some embodiments of the present disclosure, and FIG. 15 illustrates a perspective view of an example of an auxiliary electrode portion in an electrode assembly according to some embodiments of the present disclosure.

Referring to FIG. 13 and FIG. 14, an electrode assembly 102 according to some embodiments of the present disclosure may include a main electrode portion 300 including a plurality of electrodes 310 and 320 in which electrode tabs 314 and 324 are formed and a separator 330, and auxiliary electrode parts 400a and 400b disposed or arranged on both surfaces of the main electrode portion 300 and electrically connected to the electrode tabs 314 and 324 of the electrodes 310 and 320.

In some embodiments, the electrodes 310 and 320 may include a plurality of first electrodes 310 and a plurality of second electrodes 320, and the auxiliary electrode portions 400a and 400b may include a first auxiliary electrode portion 400a disposed or arranged on both surfaces of the first electrodes 310 and a second auxiliary electrode portion 400b disposed or arranged on both surfaces of the second electrodes 320. The first electrode tabs 314 of the first electrodes 310 may be coupled to the first auxiliary electrode portion 400a, and the second electrode tabs 324 of the second electrodes 320 may be coupled to the second auxiliary electrode portion 400b.

The first electrode 310, the second electrode 320, and the separator 330 may have the same configuration as the first electrode 210, the second electrode 220, and the separator 230 described above. However, referring to FIG. 14, a plurality of first electrode tabs 314 formed on one or more (e.g., each) of the first electrodes 310 may be formed at different positions so that they at least partially overlap each other in the width direction of the insulating film layer. In some embodiments, a plurality of second electrode tabs 324 formed on each of the second electrodes 320 may be formed at different positions so that they at least partially overlap each other in the width direction of the insulating film layer.

The first auxiliary electrode portion 400a may include a first auxiliary electrode 410a that is disposed or arranged on one surface of the first electrode 310 of the main electrode portion 300 and includes a first coupling tab 412a in contact with one surface of the first electrode tabs 314, and a second auxiliary electrode 420a that is disposed or arranged on the other or opposing surface of the first electrode 310 and includes a second coupling tab 422a in contact with the other or opposing surface of the first electrode tabs 314. The first auxiliary electrode portion 400a may include the first auxiliary electrode 410a and the second auxiliary electrode 420a, wherein the first auxiliary electrode 410a and the second auxiliary electrode 420a may be disposed or arranged to face each other, and the first electrodes 310 may be disposed or arranged at the center (e.g., in between the first auxiliary electrode 410a and the second auxiliary electrode 420a) in a stacked state between them.

In some embodiments, the first auxiliary electrode 410a may include a first base plate 411a made of a metal material, and a first coupling tab 412a protruding from one side of the first base plate 411a and in contact with one surface of the first electrode tabs 314.

The second auxiliary electrode 420a may include a second base plate 421a made of a metal material, and a second coupling tab 422a protruding from one side of the second base plate 421a, in contact with the other surface of the first electrode tabs 314, and coupled to the first coupling tab 412a.

Because the first base plate 411a and the second base plate 421a are coupled to the first electrode 310, they may be configured to have the same polarity as the first electrode 310. In some embodiments, in a case where the first electrode 310 functions as a positive electrode, the first base plate 411a and the second base plate 421a may be formed of a metal substrate such as aluminum or an aluminum alloy. In some embodiments, a transition metal oxide or the like may be coated on one or both surfaces of the first base plate 411a and the second base plate 421a, to form active material layers 413a and 423a, respectively. The first coupling tab 412a and the second coupling tab 422a are regions where the active material layers 413a and 423a are not formed, and they may be coupled to the first electrode tabs 314 to be a path for current flow.

The width W1 of the first coupling tab 412a may be equal to or greater than the total width W2 of the first electrode tabs 314. The first electrode tabs 314 may be spaced apart from each other in the width direction in a state in which portions of the first electrode tabs 314 overlap each other, and the first coupling tabs 412a may be formed to have the width W1 that allows contact with one or more (e.g., all) of the first electrode tabs 314 disposed or arranged as mentioned above. The width of the second coupling tab 422a may be formed to be the same as or similar to the width W1 of the first coupling tab 412a.

In some embodiments, the first coupling tab 412a and the second coupling tab 422a may be disposed or arranged to face (e.g., opposite) each other, and the first electrode tabs 314 may be disposed or arranged at the center (e.g., in between the first coupling tab 412a and the second coupling tab 422a) in a state in which the first electrode tabs 314 are stacked to be spaced apart from each other. In some embodiments, one or more (e.g., all) of the first electrode tabs 314 may contact the first coupling tab 412a and the second coupling tab 422a to be electrically connected to them.

The second auxiliary electrode portion 400b may include a first auxiliary electrode 410b, which is disposed or arranged on one surface of the second electrode 320 of the main electrode portion 300 and includes a first coupling tab 412b in contact with one surface of the second electrode tabs 324, and a second auxiliary electrode 420b, which is disposed or arranged on the other surface of the second electrode 320 and includes a second coupling tab 422b in contact with the other surface of the second electrode tabs 324. The second auxiliary electrode portion 400b may include the first auxiliary electrode 410b and the second auxiliary electrode 420b, wherein the first auxiliary electrode 410b and the second auxiliary electrode 420b may be disposed or arranged to face each other, and the second electrodes 320 may be disposed or arranged at the center (e.g., in between the first auxiliary electrode 410b and the second auxiliary electrode 420b) in a stacked state between them.

In some embodiments, the first auxiliary electrode 410b may include a first base plate 411b made of a metal material, and a first coupling tab 412b protruding from one side of the first base plate 411b and in contact with one surface of the second electrode tabs 324.

The second auxiliary electrode 420b may include a second base plate 421b made of a metal material, and a second coupling tab 422b protruding from one side of the second base plate 421b, in contact with the other surface of the second electrode tabs 324, and coupled to the first coupling tab 412b.

Because the first base plate 411b and the second base plate 421b are coupled to the second electrode 320, they may be configured to have the same polarity as the second electrode 320. In some embodiments, in a case where the second electrode 320 functions as a negative electrode, the first base plate 411b and the second base plate 421b may be formed of a metal substrate such as copper, a copper alloy, nickel, or a nickel alloy. In some embodiments, graphite or carbon may be applied to one or both surfaces of the first base plate 411b and the second base plate 421b, respectively, to form active material layers 413b and 423b. In some embodiments, the first coupling tab 412b and the second coupling tab 422b are regions where the active material layers 413b and 423b are not formed, and they may be coupled to the second electrode tabs 324 to be a path for current flow.

The width of the first coupling tab 412b may be equal to or greater than the total width of the second electrode tabs 324. The second electrode tabs 324 may be spaced apart from each other in the width direction in a state in which portions of the second electrode tabs 324 overlap each other, and the first coupling tabs 412b may be formed to have the width that allows contact with one or more (e.g., all) of the first electrode tabs 314 disposed or arranged as mentioned above. The width of the second coupling tab 422b may be formed to be the same as or similar to the width of the first coupling tab 412b.

In some embodiments, the first coupling tab 412b and the second coupling tab 422b may be disposed or arranged to face each other, and the first electrode tabs 314 may be disposed or arranged at the center (e.g., in between the first coupling tab 412b and the second coupling tab 422b) in a state in which the second electrode tabs 324 are stacked to be spaced apart from each other. In some embodiments, one or more (e.g., all) of the second electrode tabs 324 may contact the first coupling tab 412b and the second coupling tab 422b to be electrically connected to them.

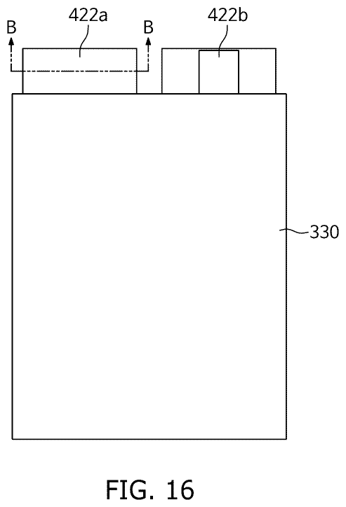

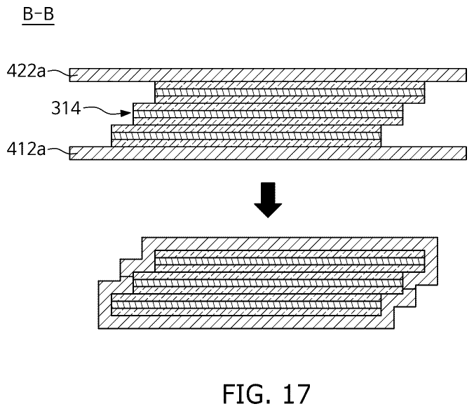

FIG. 16 illustrates an exploded plan view of an example of an electrode assembly according to some embodiments of the present disclosure. FIG. 17 illustrates a cross-sectional view of an example in which a coupling tab is coupled to a plurality of electrode tabs taken along line B-B in FIG. 16.

Referring to FIG. 16 and FIG. 17, the first electrode tabs 314 may be stacked while being spaced apart from each other in the width direction in a state in which portions thereof overlap each other. The first coupling tab 412a may be disposed or arranged on one surface of the first electrode tab 314 thus stacked, and the second coupling tab 422a may be disposed or arranged on a second surface (e.g., the other or opposing surface) thereof. The first coupling tab 412a and the second coupling tab 422a may overlap each other and may be coupled to a plurality of first electrode tabs 314 to form a path for current.

In some embodiments, the first coupling tab 412a and the second coupling tab 422a may be coupled to one or more electrode tabs 314 by ultrasonic welding while overlapping each other with the first electrode tabs 314 interposed therebetween. In some embodiments, the first coupling tab 412a and the second coupling tab 422a may be electrically connected and coupled to one or more electrode tabs 314 through laser welding or an adhesive.

A plurality of second electrode tabs may also be stacked in the same manner as the first electrode tabs, and the first coupling tab and the second coupling tab 422b may overlap each other and be coupled to the second electrode tabs to form a path for current.

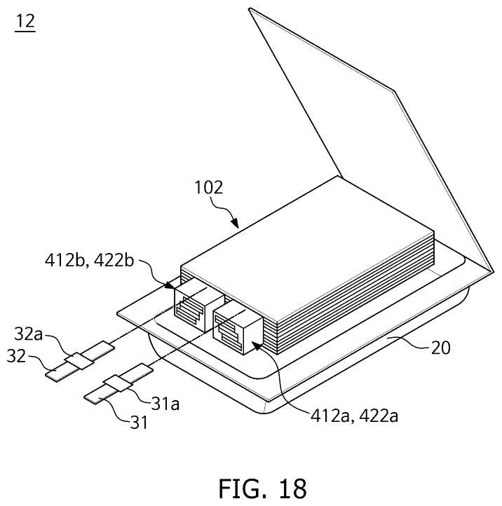

FIG. 18 illustrates an exploded perspective view of an example of a secondary battery according to some embodiments of the present disclosure.

Referring to FIG. 18, a secondary battery 12 according to some embodiments of the present disclosure may include an electrode assembly 102, a pouch 20 in which the electrode assembly 102 is accommodated, and strip terminals 31 and 32 having one end electrically connected to the electrode assembly 102 and the other end protruding outside the pouch 20. In some embodiments, the electrode assembly 102 has the same configuration as the electrode assembly 102 described above with reference to FIG. 13 to FIG. 17, so detailed descriptions thereof will be omitted. In some embodiments, the pouch 20, the strip terminals 31 and 32, and the insulating films 31a and 32a have the same configuration as the pouch 20, the strip terminals 31 and 32, and the insulating films 31a and 32a described above with reference to FIG. 12, so a detailed description thereof is omitted.

The first strip terminal 31 may have a first end coupled to a portion of the first auxiliary electrode portion of the electrode assembly 102 where the first coupling tab 412a and the second coupling tab 422a are coupled by welding or the like, and a second end thereof protruding outward to be electrically connected to an external terminal.

The second strip terminal 32 may have one end coupled to a portion of the second auxiliary electrode portion of the electrode assembly 102 where the first coupling tab 412b and the second coupling tab 422b are coupled by welding or the like, and the other end thereof protrudes outward to be electrically connected to an external terminal.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure and the claims and their equivalents, below.

### DESCRIPTION OF SOME REFERENCE SYMBOLS

10: secondary battery
20: pouch
31: first strip terminal
32: first strip terminal
101, 102: electrode assembly
200, 300: main electrode portion
210, 310: first electrode
211: first insulating film layer
212: first metal layer
213: first active material layer
214, 314: first electrode tab
220, 320: second electrode
221: second insulating film layer
222: second metal layer
223: second active material layer
224, 324: second electrode tab
230, 330: separator
300a, 400a: first auxiliary electrode portion
300b, 400b: second auxiliary electrode portion

What is claimed is:

1. An electrode assembly comprising:
a first electrode portion comprising a plurality of electrodes, a separator, and an electrode tab on each of the plurality of electrodes; and
a second electrode portion on at least one surface of the first electrode portion and electrically connected to the electrode tab.

2. The electrode assembly as claimed in claim 1, wherein each of the plurality of electrodes comprises:
an insulating film layer including an insulating material;
a metal layer on first and second surfaces of the insulating film layer;
an active material layer on the metal layer; and
the electrode tab protruding from one side of the insulating film layer, wherein first and second surfaces of the electrode tab include the metal layer without including the active material layer.

3. The electrode assembly as claimed in claim 2, wherein the electrode tab formed on each of the plurality of electrodes form a plurality of electrode tabs, wherein the plurality of electrode tabs are aligned in a thickness direction in which the plurality of electrodes are stacked.

4. The electrode assembly as claimed in claim 3, wherein the second electrode portion comprises:
a metal plate; and
a coupling tab protruding from one side of the metal plate, wherein the coupling tab is aligned with the plurality of electrode tabs, and coupled to the plurality of electrode tabs.

5. The electrode assembly as claimed in claim 4, wherein a width of the coupling tab is formed to be larger than a width of the plurality of electrode tabs, wherein the coupling tab is configured to surround the electrode tabs.

6. The electrode assembly as claimed in claim 4, wherein the coupling tab comprises:
a tab seating portion extending from the metal plate, the tab seating portion having a size corresponding to the electrode tab, and facing the electrode tab; and
a tab coupling portion extending to opposite sides of the tab seating portion and surrounding the plurality of electrode tabs.

7. The electrode assembly as claimed in claim 4, wherein the second electrode portion further comprises an active material layer formed on at least one surface of the metal plate.

8. The electrode assembly as claimed in claim 2, wherein the electrode tab formed on each of the electrodes form a plurality of electrode tabs, wherein the plurality of electrode tabs are arranged at one or more different positions, wherein at least portions of the plurality of electrode tabs overlap along a width direction of the insulating film layer.

9. The electrode assembly as claimed in claim 8, wherein the second electrode portion comprises:
a first auxiliary electrode comprising a first coupling tab arranged on a first surface of the first electrode portion and contacting a first surface of the plurality of electrode tabs; and
a second auxiliary electrode comprising a second coupling tab arranged on a second surface of the first electrode portion and contacting a second surface of the plurality of electrode tabs.

10. The electrode assembly as claimed in claim 9, wherein the first auxiliary electrode comprises:
a first metal plate; and
a first coupling tab protruding from one side of the first metal plate and in contact with a surface of the plurality of electrode tabs.

11. The electrode assembly as claimed in claim 10, wherein the second auxiliary electrode comprises:
a second metal plate; and
a second coupling tab protruding from one side of the second metal plate and in contact with a second surface of the plurality of electrode tabs, wherein the second coupling tab is coupled to the first coupling tab.

12. The electrode assembly as claimed in claim 11, wherein the first coupling tab and the second coupling tab are ultrasonically welded and overlap each other with the plurality of electrode tabs interposed therebetween.

13. The electrode assembly as claimed in claim 9, wherein a width of the first coupling tab and a width of the second coupling tab are equal to or greater than a total width of the plurality of electrode tabs.

14. The electrode assembly as claimed in claim 1, wherein the plurality of electrodes comprise a plurality of first electrodes and a plurality of second electrodes, and
the second electrode portion comprises a first auxiliary electrode portion arranged on at least one surface of the plurality of first electrodes and a second auxiliary electrode portion arranged on at least one surface of the plurality of second electrodes.

15. The electrode assembly as claimed in claim 14, wherein a first electrode tab on a first electrode of the plurality of first electrodes and a second electrode tab on a second electrode of the plurality of second electrodes protrude in the same direction without overlapping each other in a thickness direction in which the plurality of electrodes are stacked.

16. The electrode assembly as claimed in claim 14, wherein a first electrode tab on a first electrode of the plurality of first electrodes and a second electrode tab on a second electrode of the plurality of second electrodes protrude in opposite directions.

17. A secondary battery comprising:
an electrode assembly;
a pouch in which the electrode assembly is accommodated; and
a strip terminal having a first end electrically connected to the electrode assembly and a second end protruding from outside of the pouch,
wherein the electrode assembly comprises:
a first electrode portion comprising a plurality of electrodes, a separator, and an electrode tab on each of the plurality of electrodes; and
a second electrode portion on at least one surface of the first electrode portion, electrically connected to the electrode tab of the plurality of electrodes, and coupled to one end of the strip terminal.

18. The secondary battery as claimed in claim 17, wherein each of the plurality of electrodes comprises:
an insulating film layer having an insulating material;
a metal layer on first and second surfaces of the insulating film layer;
an active material layer on the metal layer; and
the electrode tab protruding from one side of the insulating film layer, wherein the first and second surfaces of the electrode tab include the metal layer without including the active material layer.

19. The secondary battery as claimed in claim 18, wherein the electrode tab formed on each of the plurality of electrodes form a plurality of electrode tabs, wherein the plurality of electrode tabs are aligned in a thickness direction in which the plurality of electrodes are stacked, and
the second electrode portion comprises:
a metal plate; and
a coupling tab protruding from one side of the metal plate, wherein the coupling tab is aligned with the plurality of electrode tabs, and surround the plurality of electrode tabs to be coupled thereto.

20. The secondary battery as claimed in claim 18, wherein the electrode tab formed on each of the plurality of electrodes form a plurality of electrode tabs, wherein the plurality of electrode tabs are arranged at one or more positions, wherein at least portions of the plurality of electrode tabs overlap along a width direction of the insulating film layer, and
the second electrode portion comprises:
a first auxiliary electrode comprising a first coupling tab arranged on one surface of the first electrode portion and in contact with a first surface of the plurality of electrode tabs; and
a second auxiliary electrode comprising a second coupling tab arranged on a second surface of the first electrode portion and coupled to the first coupling tab and further in contact with a second surface of the plurality of electrode tabs.
